(19) United States
(12) Patent Application Publication
(10) Pub. No.: US 2018/0293479 A1
(43) Pub. Date: Oct. 11, 2018

(54) METHOD AND PLANT FOR THE MANUFACTURE OF RFID DEVICES

(71) Applicant: AUTOMATION 4 INDUSTRIAL SOLUTIONS S.R.L., Muggio' (MB) (IT)

(72) Inventors: Paolo STEFANELLI, Milano (IT); Giovanni NATALIS, Pietra Ligure (IT)

(73) Assignee: AUTOMATION 4 INDUSTRIAL SOLUTIONS S.R.L., Muggio' (MB) (IT)

(21) Appl. No.: 15/766,624

(22) PCT Filed: Sep. 27, 2016
(86) PCT No.: PCT/IB2016/055770

§ 371 Date: Apr. 6, 2018

(30) Foreign Application Priority Data
Oct. 30, 2015 (IT) 102015000067455

(51) Int. Cl. G06K 19/077

(52) U.S. Cl. CPC G06K 19/07718; G06K 19/07749

(57) ABSTRACT

A continuous laminar support is driven in accordance with successive handling steps, mutually interspersed with stop phases, along a processing line including a plurality of work stations each carrying at least one applicator of a constructive component of an RFID device on the laminar support. In conjunction with each handling step, at least one RFID module in correspondence of at least a module application station and at least one antenna in correspondence of at least one antenna application station are applied on the laminar support. In conjunction with each of the stop phases, at least in one of the work stations the position of a reference index arranged on the laminar support is detected, and the constructive component of the RFID device is applied in a predetermined position with respect to said reference index.

The present invention relates to a method and a plant for the manufacture of RFID devices.

More particularly, the invention relates to the manufacture of RFID devices consisting of an RFID module as an integrated circuit provided with at least an antenna as a wire made of copper or other conductive material, enclosed between a laminar support, for example as a sheet of paper or other material, and a laminar covering layer.

It is known the manufacturing of RFID devices by means of productive plants comprising several work stations, for example in which a laminar support made of paper material is sequentially subjected to the respective operations required for the simultaneous manufacture of a plurality of RFID devices.

At the end of processing, the RFID devices formed on the laminar support lend themselves to be individually separated from each other to be destined to their final use.

In production lines of the above indicated type it is for example known the use a module application station, which applies a plurality of RFID modules on a laminar support as an adhesive sheet.

The adhesive sheet bearing the RFID modules is then transferred to an antenna application station by which each of the RFID modules is associated to an antenna in the form of metal wire.

For example, the document WO 2006/079913 describes a antenna application station provided with a plurality of deposition heads each of which depositing a metal wire on the adhesive sheet, supported by a movable supporting plane according to three mutually perpendicular axes of a Cartesian system.

The Applicant believes that the current systems for the realization of RFID devices may be significantly improved in many aspects, for example in terms of structural simplicity, productivity, operational flexibility and qualitative precision of the final product.

In this respect, the Applicant has noted that, for the purposes of a correct execution of the processing, the application of components of each RFID module according to a particularly precise and accurate positioning is of decisive importance.

A correct application of the components comprises an equally accurate positioning of the laminar support under the equipment for the application of the components. An inaccurate placement of the laminar support would constitute a misapplication of the components, compromising the functionality of the produced RFID devices.

To meet these requirements, it is currently necessary to provide, in each of the work stations, delicate and complex mechanisms relating to the handling and positioning of the laminar support.

The presence of these devices, however, results in a considerable increase in constructive complexity of the equipment and overall dimensions, with side effects also in terms of operational reliability.

The object of the present invention is to improve the state of the art.

In particular, it is to propose a production plant in which RFID devices can be realized on a laminar support in sheet form or continuous tape, moved longitudinally through work stations arranged according to a linear path along a processing line, preferably as a result of a traction exerted downstream of the processing line, compensating for any lateral and/or longitudinal deviations of the laminar support, due to the driving in each of the work stations where this compensation can be appropriate.

In this respect, the Applicant considers appropriate to provide reference indexes substantially equally spaced along the laminar support, so that it is possible to position each component of RFID devices according to a desired positioning with respect to one or more of the above reference indexes.

More particularly, the object of this invention is a method for the manufacture of RFID devices, comprising the steps of: translating longitudinally a continuous laminar support in accordance with successive handling steps, mutually interspersed with stop phases, along a processing line comprising a plurality of work stations each carrying at least one applicator of a constructive component of an RFID device on the laminar support; applying, at every handling step, at least one RFID module in correspondence with at least one module application station forming part of said plurality of work stations; applying, at every handling step, at least one antenna in correspondence with at least one antenna application station forming part of said plurality of work stations; and in at least one of the work stations, detecting, in conjunction with each of said stop phases, the position of a reference index arranged on the laminar support, and applying said constructive component in a predetermined position with respect to said reference index.

In accordance with a further aspect, the invention proposes a plant for the manufacture of RFID devices, comprising: a plurality of work stations disposed consecutively along a processing line; traversing devices for driving a longitudinally continuous laminar support, according to subsequent handling steps mutually intercalated by stop phases, along said processing line; and a plurality of applicators, each associated with one of the work stations to apply at least a constructive component of an RFID device on the laminar support. The work stations include preferably at least one module application station configured to apply, at every handling step, more precisely during each of the stop phases, at least one RFID module, and at least one antenna application station configured to apply, at each step handling, more precisely during each of the stop phases, at least one antenna coupled to said RFID module. In at least one of said work stations, detection devices are further provided, preferably in conjunction with each of said stop phases, the position of a reference index carried by the laminar support, and a handling device for adjusting the position of at least one of said applicators with respect to said reference index.

The applicator operates therefore on the laminar support in a predetermined position with respect to said reference index.

In one or both the above aspects, the present invention can also advantageously have one or more of the following preferable features.

Preferably, the application of said constructive component comprises the action of moving the applicator parallel to the laminar support, along at least a mutually perpendicular first and/or second axis.

Preferably, said laminar support comes from a feed unit and said reference indexes are produced on the laminar support at a stretch between the feed unit and the module application station.

Preferably, said reference indexes are mutually spaced apart according to a substantially constant distribution pitch, so that at each handling step at least one of said reference indexes is stopped at each of said work stations.

Preferably, at each stop phase of the laminar support at least two cycles of RFID module application are performed according to the respective arrays in mutually spaced apart positions along the longitudinal development of the continuous laminar support.

Preferably, in each of the arrays of RFID modules applied in one of said application cycles a respective set of antennas is combined, which are applied in conjunction with respective stop phase of the laminar support.

Preferably, each RFID module forming part of a first array receives at least one antenna at a first antenna application station, and each RFID module belonging to a second array receives at least one antenna at a second antenna application station.

Preferably, said translation devices include a driving unit operating downstream of the work stations.

At least one marking station to make said reference indexes on the laminar support is preferably provided.

Preferably, said marking station operates between a feed unit of the laminar support and the module application station.

Preferably, at least one of said work stations comprises a respective handling device for translating the applicator along at least two, more preferably at least three mutually orthogonal handling axes.

Preferably, at least one of said handling axes is parallel to a supporting plane of the laminar support.

Preferably, in at least one of said work stations said applicator is supported by a support arm parallel spaced from a support surface of the laminar support.

Preferably, said support arm has one end cantilevered to the respective handling device.

Preferably, at least one of said work stations comprises a plurality of applicators carried by respective operative heads.

Preferably, said operating heads can be placed transversely to the longitudinal development of the laminar support, preferably along a supporting arm being part of said handling device.

Preferably, at least one of said work stations comprises an interchangeable positioning template removably engaged to said support arm.

Preferably, at least one of said work stations comprises an interchangeable positioning template rigidly engaged to said support arm.

Preferably, the positioning template carries cooperating engagement seats with respective abutment elements carried by said heads to fix the positioning along the support arm.

Preferably, a first antenna application station and at least a second antenna application station are provided consecutively arranged along the processing line.

Preferably, said detection devices include a camera.

Preferably, the camera is fixed to the handling device.

Preferably, the camera is oriented towards a support surface of the laminar support.

Further features and advantages will become more apparent from the detailed description of a preferred, but not exclusive, embodiment of a method for the manufacture of RFID devices, and of a plant operating according to said method, in accordance with the present invention.

Such description will be set forth hereinafter with reference to the accompanying drawings given only for illustrative purposes and not by way of limitation, in which:

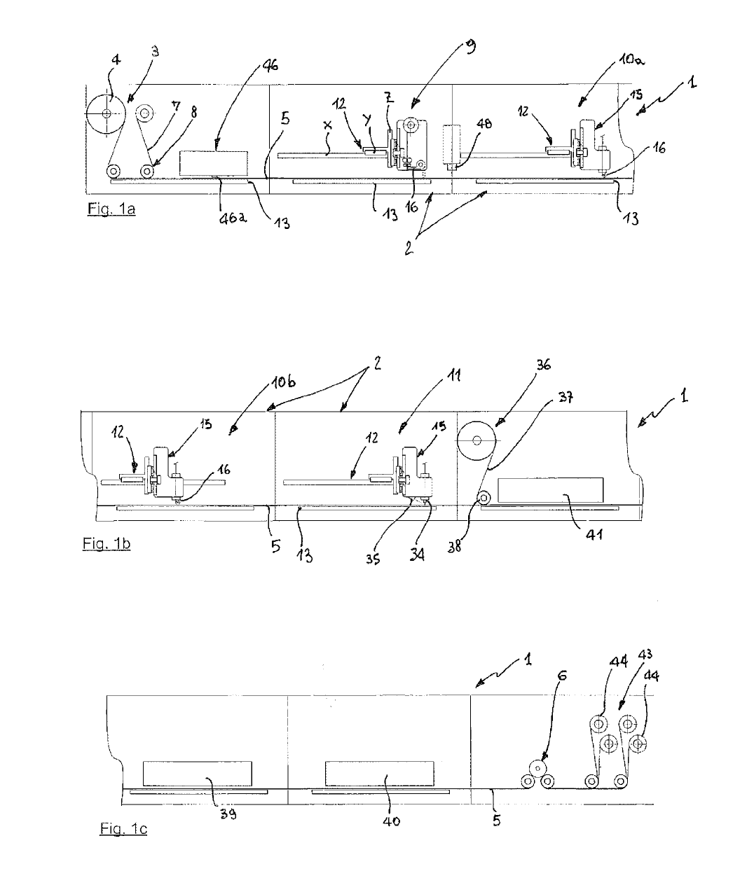

FIGS. 1a, 1b and 1c show diagrammatically in a side view, respectively, consecutive portions of a plant realized in accordance with the present invention;

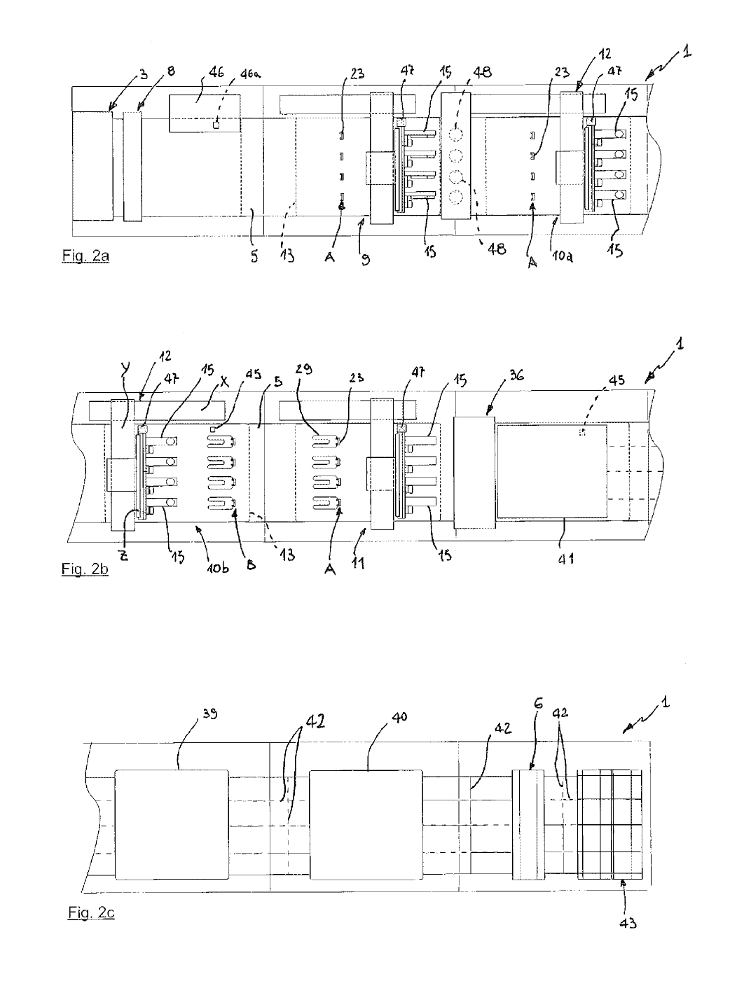

FIGS. 2a, 2b and 2c are plan views of the portions of the plant of FIG. 1;

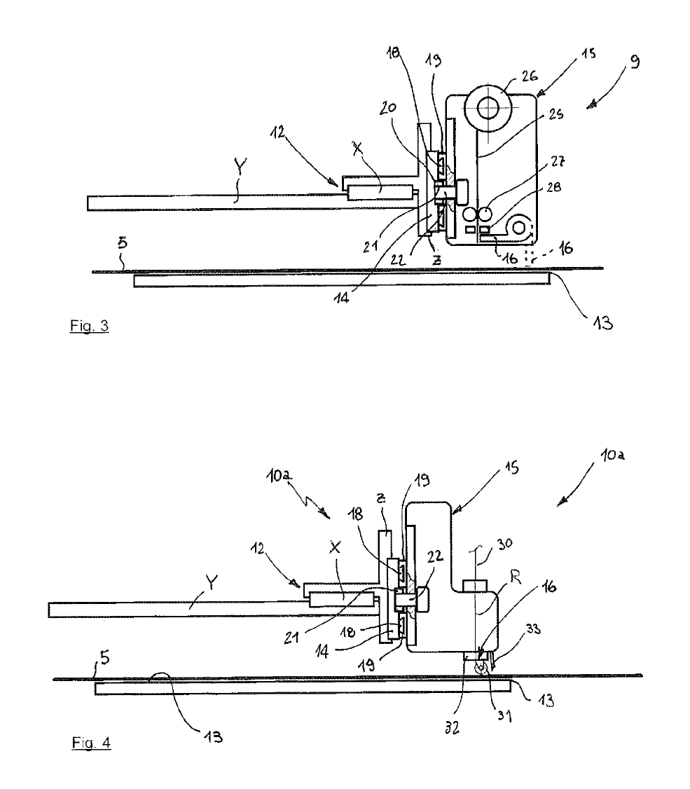

FIGS. 3, 4 and 5 are schematic representations respectively illustrating a module application station, an antenna application station and a fixing station in a side view;

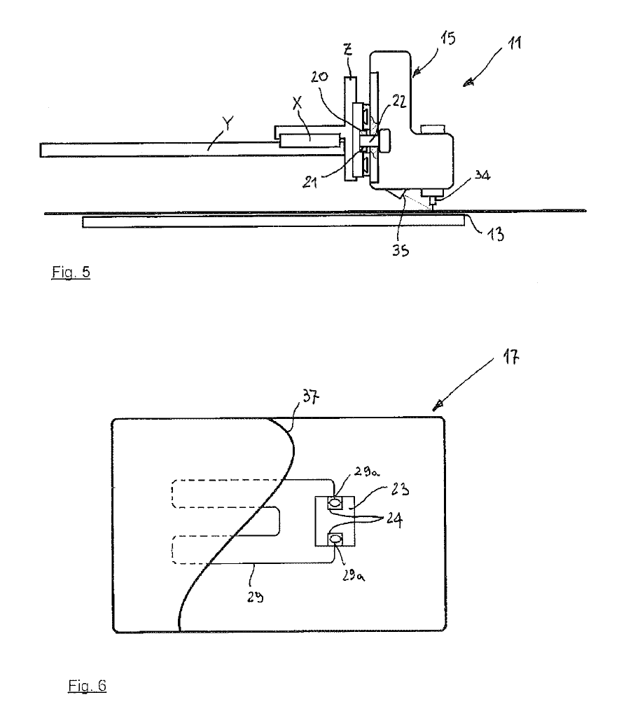

FIG. 6 shows an RFID device obtainable in accordance with the present invention.

In FIGS. 1a, 1b and 1c, 2a, 2b and 2c a plant for the manufacture of RFID devices 17 is generally illustrated, operating according to a method according to the present invention.

The system includes a processing line 1 defined by a plurality of work stations 2 consecutively aligned in mutual juxtaposition, preferably along a substantially rectilinear direction.

Upstream of the processing line 1 is a feed assembly 3 carrying, for instance, a reel or other storage element 4 from which a continuous laminar support 5 is progressively withdrawn and made to advance along the processing line 1 by a drive assembly 6 disposed downstream.

The laminar support 5 may for example be realized in form of a sheet of paper, plastic or other material, preferably provided with an adhesive layer applied on its upper surface. A protective film 7 on the previously applied adhesive layer is removed upon the action of a rewinding assembly 8 located in the proximity of the feed assembly 3, in conjunction with the advancement of the laminar support 5.

The advancement of the laminar support 5 by the drive assembly 6 preferably occurs according to a step-by-step movement. In other words, the continuous laminar support 5 is moved longitudinally along the processing line 1 in subsequent handling steps, mutually intercalated by stop phases. The amplitude of each handling step is substantially equal to the distance between two consecutive work stations 2, or to a submultiple of said distance.

The work stations 2 may for example include at least one module application station 9 and at least one antenna application station 10a, 10b and, preferably, at least one fixing station 11. In the example shown, a first and a second antenna application station 10a, 10b, respectively contiguous, are provided.

In the accompanying drawings, 12 generally indicates handling devices present in one or more of the work stations 2, to apply on the laminar support 5, at each working cycle, at least a constructive component of an RFID device.

In the illustrated example, the handling devices 12 are installed on the module application station 9, on each of the antenna application stations 10a, 10b and on the fixing station 11.

Each handling device 12 is positioned above a support surface 13 on which the laminar support 5 shifts, and rigidly engages one end of a support arm 14 extending and projecting above the support surface 13. The support arm 14, spaced in parallel from the support surface 13, carries at least one operating head 15 specifically configured for the application of the respective constructive component by means of a respective applicator 16. In a preferential embodiment, the support arm 14 is associated to a plurality of operating heads 15, for example four, each carrying a respective applicator

It may be advantageously provided that the operating heads 15 belonging to a same work station 2 are removably positionable along the respective support arm 14, in a direction transverse to the longitudinal development of the laminar support 5. To this end, the support arm 14 is preferably provided with one or more sliding guides 18, operatively engaged by respective shoes 19 carried by each of the operating heads 15.

An interchangeable positioning template 20 can also be fixed to the support arm 14 carrying a plurality of engagement seats 21, each of which cooperates with a respective abutment element 22 carried by one of the heads, to fix the positioning along the support arm 14. Setting operations of the work station 2 are thus simplified, since the number and positioning of the operating heads 15 can be easily changed depending on the needs, through eventual replacement of the positioning template 20.

Each handling device 12 provides the movement each operating head 15 and of the respective applicator 16 preferably according to at least three axes Y, X, Z, respectively orthogonal. For the purposes of the present description, it is possible identify a longitudinal axis of movement Y, parallel to the longitudinal development of the continuous laminar support 5, a transverse axis of movement X, perpendicular to the longitudinal development of the laminar support 5, and a vertical axis of movement Z, with respect to support surface 13 of the laminar support 5. The longitudinal axis of movement Y and transverse axis of movement X are coplanar with each other or arranged on parallel planes, respectively.

The handling devices 12 of the different work stations 2 may be substantially identical to each other. On the contrary, the operating heads 15 and the respective applicators 16 are each specifically configured according to the operation to be performed in the respective work station 2.

In this respect, it is provided that the handling device 12 installed in the module application station 9 is associated with one or more first operative heads 15 each of which is configured to apply on the laminar support 5, at each handling step, and more precisely during each of the stop phases, a respective RFID module 23, preferably made in the form of microchips.

To this end, each operating head 15 associated with the module application station 9, not described in detail as achievable in different ways, may for example comprise a supply reel 26 of the RFID modules 23, preferably distributed along a continuous tape 25 coming from the reel itself. Pulling means 27 operating on the tape shall individually transfer the RFID module 23 to a cutting unit 28. The cutting unit 28 is selectively operable to separate from the continuous tape 25 each RFID module 23 together with a length of the tape itself, making it available for the relevant applicator 16 of RFID modules 23. The applicator 16 of the RFID modules 23 may for example comprise a movable gripping member, preferably by means of an angular rotation, between a gripping position, in which it retains the RFID module 23 near the cutting unit 28, and a release position, in which it is oriented towards the support surface 13, in order to release the RFID module 23 on the underlying laminar support 5, preferably as a result of descent along the vertical axis of movement Z.

Each of the operating heads 15 present in the handling device 12 installed in each of the antenna application station 10a, 10b is in turn configured to be applied at least one antenna 29 on the laminar support 5, at each handling step, more precisely during each stop phase. Each antenna 29 is preferably formed by depositing on the laminar support 5 a metallic wire or other conductive material, preferably copper treated with an external insulation coating. To this end, each of the operating heads 15 installed in the antenna application station 10a, 10b may for example comprise guide members (not shown) operating on the conductive wire 30 coming from a respective supply reel, in order to lead it in correspondence of the applicator 16 of antennas 29, made for example in the form of idler roll 31, rotatable around a horizontal axis. The idler roll 31 may be carried by a pivot 32 pivoting around a vertical pivot axis R. A cutting member 33 cuts the conductive wire 30 near the idle roller 31, once the application is complete.

Each of the antennas 29 applied on the laminar support 5 is coupled to one of the RFID modules 23. For example, each antenna 29 may have its opposite ends 29a placed in contact relationship with respective terminals 24a carried by the RFID module

Preferably, with reference to the direction of advancement of the laminar support 5, the module application station 9 is arranged upstream of the antenna application station(s) 10a, 10b.

Each of the operating heads 15 present in the handling device 12 installed in the fixing station 11, arranged downstream of the antenna application station(s) 10a, 10b, is configured to stably fix each antenna 29 to the respective RFID module 23, for example by making welds at the terminals 24 of the RFID module itself. To this end, each operating head 15 can for example comprise a dispenser 34 of filler material and heating bodies, for example a laser emitter 35, for applying and melting a predetermined quantity of filler material at each of the terminals 24 of the RFID module 23, where the ends of the antenna 29 were previously placed.

It can be also provided at least one covering unit 36 located downstream of the fixing station 11 and configured to apply at least a covering layer 37 on the laminar support 5. Similarly to the laminar support 5, the covering layer 37 can be also realized in the form of continuous sheet in paper or plastic material, and is for example coupled to the laminar support itself by means of a respective applicator in the form of roller 38.

The work stations 2 can be intercalated with auxiliary stations 39, 40 configured for performing additional processing operations on the RFID modules 23 being processed. For example, downstream of the covering unit 36 a testing station 39 may be provided, upon the action of which the operation of RFID devices 17 obtained is tested, and a possible printing station 40 for realizing identifying graphic patterns on the same RFID devices 17. The printing station 40, if located downstream of the testing station 39, can also be used to mark the RFID devices 17 that have not passed the tests performed in the testing station itself.

Downstream of the covering unit 36 at least one die-cutting station 41 can be also provided, which is configured for making mutually coupled separation 42 and/or pre-breaking notches in the laminar support 5 and the covering layer 37, so as to facilitate the mutual separation of the RFID devices 17 at a later time.

In the illustrated example, the driving group 6 is arranged downstream of the processing line 1. One or more of the work 2 and/or auxiliary stations 39, 40, for example the testing station 39 and/or the printing station 40 and/or the die-cutting station 41, can be arranged upstream of the driving group 6. A collection unit 43 arranged downstream of the processing line 1 receives the RFID devices 23, for example by wrapping them in the form of one or more tapes on respective collection reels 44 after any possible longitudinal cutting operation.

In accordance with the invention, on the continuous laminar support 5 reference indexes 45 are arranged mutually spaced apart according to a substantially constant distribution pitch, preferably equal to the handling pitch of the laminar support itself with the processing line 1. At each handling step, at least one of the reference indexes 45 is therefore stopped at each of the work stations 2.

In accordance with a not shown embodiment example, the reference indexes 45 can be realized on the laminar support 5 before its use in the plant 1.

In a preferred embodiment example, shown in the accompanying figures, the reference indexes 45 are realized by means of a marking station 46 operatively interposed between the feed unit 3 and the module application station 9, preferably upstream of the rewinding unit 8. The marking station 46 can for example comprise at least one punch 46a movable alternately through the laminar support 5 to realize the reference indexes 45 in the form of shaped openings, for example square in shape, distributed along at least one of its longitudinal edges.

Alternatively, the marking station 46 can for example be configured to realize the reference indexes 45 in the form of graphics patterns printed on the laminar support 5.

In conjunction with each of said stop phases, the position of each applicator 16 can be advantageously adjusted with respect to at least one of the reference indexes 45 carried by the laminar support 5.

To this end, detection devices can be used comprising, for example, at least a digital camera 47 directed towards the support surface 13, or other suitable reading device (for example an electromechanical-type device) operatively associated to one or more of the work stations 2 to detect the position of reference index 45 on the laminar support 5, when the latter is stopped at the respective work station 2.

Preferably, at least the module application stations 9, the first and second antenna application stations 10a, 10b, and the fixing station 11 are each provided with at least one respective camera 47. Additional cameras may be associated, where appropriate, with other work stations 2, for example, the die-cutting station 41 and/or the printing station 40.

Each camera 47 can be for example fixed to one end of the support arm 14 carried by the respective handling device 12. During the movement of the laminar support 5, the handling device 12 can be also actuated so as to place the camera 47 at a predetermined stop position, such that at each stop phase between two successive handling steps at least one of the reference indexes 45 carried by the laminar support 5 is located within a reading area framed by the camera.

The position of the reference index 45 detected inside the reading area is used as a reference for positioning and/or moving the applicators 16 for the proper positioning of the RFID component.

More in particular, for example, an electronic programmable control unit (not shown) can be stored data of the positions to be occupied by the individual RFID components on the laminar support 5 in the stop phase at each of the respective work stations 2.

Following the execution of each handling step by means of the driving group 6, the laminar support portions 5 each carrying at least one of said reference indexes 45 are stopped at each one of the work stations 2.

Each of the cameras 47 attached to the application stations 9, 10a, 10b, 11 detects the position of the reference index 45 on the laminar support portion 5 during the stop phase on the respective support surface 13, and sends to the electronic programmable control unit information indicative of that position.

In a preferred example, the camera 47 is configured to detect the position of the reference index 45 at least along a direction parallel to the longitudinal axis of movement X, that is to say parallel to the longitudinal development of the laminar support 5 and to the handling direction of the same. In addition or alternatively, the camera 47 can be configured to detect the position of the reference index 45 along a direction parallel to the transverse axis of movement X.

Based on the information received from the camera 47, the electronic control unit controls the handling device 12 installed in each application station 9, 10a, 10b, 11, by translating the respective operating heads 15 parallel to the longitudinal Y and/or transverse X axes of movement, at a geometrical plane parallel to the support surface of the laminar support 5. Each applicator 16 is thus provided with a predetermined position in relation to the reference index 45 carried by the respective portion of the laminar support 5.

Therefore, at each application station, the operation of the operating heads 15 and of the applicators 16 can be controlled so as to determine, with a descent of the applicator 16 along the vertical axis of movement Z, the application of the components of the RFID device (RFID modules 23, antennas 29, welds) at respective predetermined points in relation to each of the respective reference indexes 45.

An accurate and precise positioning of each of the components of the RFID device 17 is thus ensured also in the event of lateral displacement and/or elongations or shortenings of the laminar support 5, for example due to stresses transmitted along the latter for the purpose of step-by-step movement.

Preferably, the working cycle performed in the module application station 9 at each stop phase of the laminar support 5 ensures that the respective handling device 12 performs at least two application cycles, in order to apply respective arrays A, B of the RFID modules 23 at positions mutually spaced along the longitudinal development of the laminar support 5. To this end, for example, at the end of the application of a first array A of RFID modules 23, the applicators 16 can be again raised along the vertical axis of movement Z to determine a translation of the operating heads 15 along the axis of longitudinal movement Y. Upon completion of translation, the applicators 16 are again lowered along the vertical axis of movement Z to determine the application of a second array B of RFID modules 23, at a predetermined distance from the first array A previously applied.

The first and the second array A, B of RFID modules 23 applied on the laminar support 5 during the working cycle described above are subjected, respectively in succession, to the action of the first and second antenna application station 10a, 10b as a result of the execution of two successive handling steps of the laminar support itself.

One or more control cameras 48 can be arranged along the processing line 1, for example between the module application station 9 and the antenna application station 10a, 10b, to detect the position of the RFID modules 23 applied on the laminar support 5 during the translation of the laminar support 5 away from the module application station 9. The data relating to the position of the RFID modules 23 applied on the laminar support 5 are sent to the electronic control unit that, in the event of excessive deviation from the previously stored reference data, can for example emit a warning signal and/or determine the stopping of the production line.

1. A method for the manufacture of RFID devices, comprising:
translating longitudinally a continuous laminar support in accordance with successive handling steps, mutually interspersed with stop phases, along a processing line comprising a plurality of work stations each carrying at least one applicator of a constructive component of an RFID device on the laminar support;
applying, in conjunction with each of said stop phases, at least one RFID module in correspondence with at least one module application station forming part of said plurality of work stations;
applying, in conjunction with each of said stop phases, at least one antenna in correspondence with at least one antenna application station forming part of said plurality of work stations; and
in at least one of the work stations, detecting, in conjunction with each of said stop phases, the position of a reference index arranged on the laminar support, and applying said constructive component in a predetermined position with respect to said reference index.

2. The method according to claim 1, wherein the application of said constructive component comprises the action of moving the applicator parallel to the laminar support, along at least a mutually perpendicular first and/or second axis.

3. The method according to claim 1, wherein said laminar support comes from a feed unit and said reference indexes are produced on the laminar support at a stretch between the feed unit and the module application station.

4. The method according to claim 1, wherein said reference indexes are mutually spaced apart according to a substantially constant distribution pitch, so that at each handling step at least one of said reference indexes is stopped at each of said work stations.

5. The method according to claim 1, wherein at each stop phase of the laminar support at least two cycles of RFID module application are performed according to the respective arrays in mutually spaced apart positions along the longitudinal development of the continuous laminar support.

6. The method according to claim 5, wherein each RFID module forming part of a first array is coupled to at least one antenna at a first antenna application station and each RFID module belonging to a second array is coupled to at least one antenna at a second antenna application station.

7. A plant for the manufacture of RFID devices, comprising:
a plurality of work stations arranged consecutively along a processing line;
translation devices longitudinally conducting a continuous laminar support, in accordance with successive handling steps, mutually interspersed with stop phases, along said processing line; and
a plurality of applicators, each associated with one of the work stations to apply at least a constructive component of an RFID device on the laminar support, wherein
said work stations include at least one module application station configured to apply, in conjunction with each of said stop phases, at least one RFID module and at least one antenna application station configured to apply, in conjunction with each of said stop phases, at least one antenna coupled to said RFID module; and wherein
at least one of said work stations comprises sensing devices to detect the position of at least one reference index carried by the laminar support, and at least one handling device to adjust the position of at least one of said applicators with respect to said reference index.

8. The plant according to claim 7, wherein said translation devices include a driving unit operating downstream of the work stations.

9. The plant according to claim 7, further comprising at least one marking station to achieve said reference indexes on the laminar support.

10. The plant according to claim 9, wherein said marking station operates between a feed unit of the laminar support and the module application station.

11. The plant according to claim 7, wherein at least one of said work stations comprises a respective handling device for translating the applicator along at least three mutually orthogonal handling axes.

12. The plant according to claim 7, wherein in at least one of said work stations, said applicator is supported by a supporting arm having one cantilevered end with respect to the respective handling device.

13. The plant according to claim 7, wherein at least one of said work stations comprises a plurality of applicators carried by respective operating heads.

14. The plant according to claim 13, wherein said operating heads can be placed transversely to the longitudinal development of the laminar support, preferably along a supporting arm being part of said handling device.

15. The plant according to claim 14, wherein at least one of said work stations comprises an interchangeable positioning template rigidly engageable to said supporting arm and bearing insertion seats cooperating with respective abutment members carried by said operating heads to fix the positioning along the supporting arm.

16. The plant according to claim 7, comprising a first antenna application station and at least a second antenna application station consecutively arranged along the processing line.
